(19) United States
(12) Patent Application Publication
(10) Pub. No.: US 2021/0393006 A1
(43) Pub. Date: Dec. 23, 2021

(54) SYSTEM AND METHOD FOR ATTACHING EMBROIDERED DESIGN ELEMENTS TO CLOTHING ARTICLES USING MAGNETISM

(71) Applicant: Stephen Roy Nagel, Las Vegas, NV (US)

(72) Inventor: Stephen Roy Nagel, Las Vegas, NV (US)

(21) Appl. No.: 17/354,137

(22) Filed: Jun. 22, 2021

Related U.S. Application Data
(60) Provisional application No. 63/042,233, filed on Jun. 22, 2020.

(51) Int. Cl. A44C 25/00; H01F 7/02

(52) U.S. Cl. CPC A44C 25/00; H01F 1/057; H01F 7/02

(57) ABSTRACT

A system and method for attaching design elements to an article of clothing are provided. The system includes an embroidered design element with a conductive metal layer coupled to a back surface of the embroidered design element. The system further includes a magnetic member. In operation, the conductive metal layer is releasably and magnetically coupled to the magnetic member with an article of clothing between the conductive metal layer and the magnetic member.

### CROSS REFERENCE TO RELATED APPLICATION

This application claims priority to U.S. Provisional Patent Application to Stephen Roy Nagel entitled “SYSTEM AND METHOD FOR ATTACHING EMBROIDERED DESIGN ELEMENTS TO CLOTHING ARTICLES USING MAGNETISM,” Ser. No. 63/042,233, filed Jun. 22, 2020, the disclosure of which is hereby incorporated entirely herein by reference.

### BACKGROUND OF THE INVENTION

### Technical Field

This invention relates generally to a system and method for attaching design elements to an article of clothing and more particularly to a system and method for attaching design elements to clothing utilizing magnetism.

### State of the Art

Typically hats and other articles of clothing (or garment) use embroidered designs (as an example but not limited to—i.e., could be other material including cloth, metal, plastic, leather-such materials hereinafter referred to as “embroidery/embroidered/patches”) as a part of the hat or garment. The garment for example is usually directly embroidered on an automated machine with various threads of many colors that are used to create the final design or the patch. Further, many “patches” are made using the embroidery method and then attached to the hat or garment using traditional sewing, adhesive, Velcro or a pin may be used to attach the embroidered design.

Once the hat or garment is embroidered, the hat or garment is considered permanently decorated as the thread is permanently a part of the garment or has been permanently sewn or adhered to the hat or garment.

Further, some hats or garments do not lend themselves to the embroidery process such as cowboy hats or certain leather garments the owner is concerned that the item if done incorrectly would be permanently damaged and the replacement cost outweighs the direct embroidery process or the sewing or adhesion of a “patch”.

Accordingly, there is a need for an improved system and method for attaching embroidered design elements to an article of clothing.

### SUMMARY OF THE INVENTION

The present invention relates to a system and method for attaching design elements to clothing utilizing magnetism.

An embodiment includes a system for attaching design elements to an article of clothing, the system comprising: an embroidered design element; a conductive metal layer coupled to a back surface of the embroidered design element; and a magnetic member, wherein the conductive metal layer is releasably and magnetically coupled to the magnetic member with an article of clothing between the conductive metal layer and the magnetic member. The conductive metal layer may be a film. The film may be a ferrous metal. The film may be a metal laden polymer adhesive. The film may be a steel metal alloy foil. The film may have a thickness in the range of about 2 to about 10 millimeters. The film may be bendable. The magnetic member may be flexible. The magnetic member may be a rare earth magnet. The rare earth magnet may be neodymium. The magnetic member may be removably attached to an inner surface of the article of clothing.

The magnetic member may be permanently attached to an inner surface of the article of clothing. The magnetic member may be affixed to wire on the inner surface of the article of clothing.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a perspective exploded view of a system for attaching and embroidered design element to clothing according to an embodiment; and

FIG. 2 is another perspective exploded view of a system for attaching and embroidered design element to clothing according to an embodiment.

### DETAILED DESCRIPTION OF EMBODIMENTS OF THE INVENTION

As discussed above, embodiments of the present invention relate to a system and method for attaching design elements to clothing utilizing magnetism.

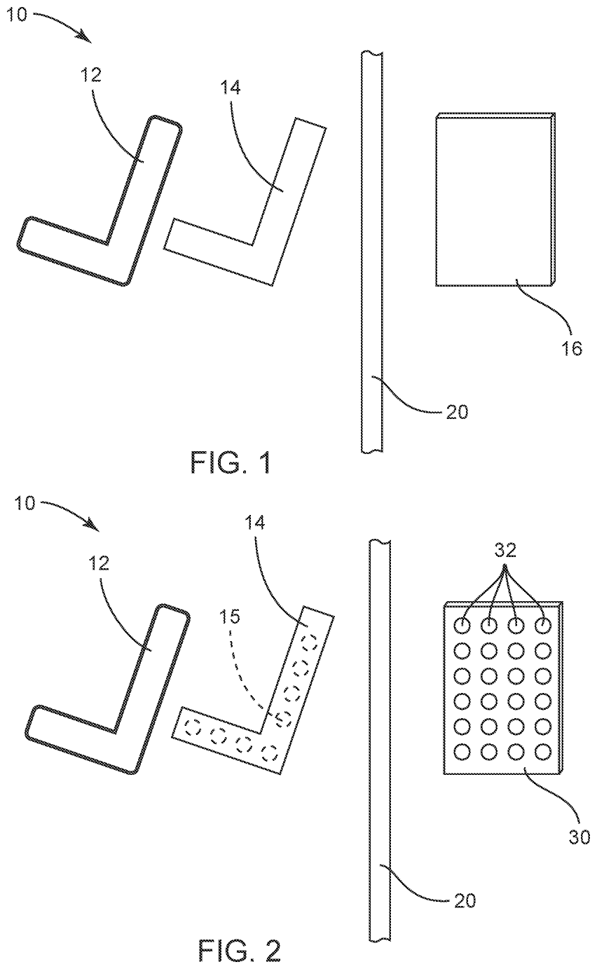

Referring to FIGS. 1 and 2, embodiments include and embroidery attachment system 10 that combines magnetism properties by attaching or otherwise creating a conductive metal layer 14 on the underside or backside of an embroidered design element 12 to place up against an outer surface of an article of clothing 20, and then utilizing a magnetic member 16 on an inner surface of the article of clothing 20 to hold the embroidered design element 12 to the article of clothing 20 by magnetic attraction between the conductive metal layer 14 and the magnetic member 16 through the article of clothing 20. It will be understood that while an embroidered design element 12 is discussed and shown, the design element 12 may be fabric or other woven material to form the design element 12. It will further be understood that the conductive metal layer may be a substrate formed of non-metal material with a plurality of metal members 15 coupled to or formed within the non-metal material.

The magnetic member 16 (magnetic member 30 with magnets 32 in FIG. 2) may include a magnet or magnets of sufficient magnetic polarity and strength to hold the embroidered design element 12 in place on the outer surface of the article of clothing 20. The article of clothing may be a hat, a shirt, pants or the like and may be formed of fabric, cloth, leather, or the like as an example. This allows the article of clothing 20 to appear to be decorated using the embroidery method of decoration without permanently altering the actual material forming the article of clothing 20. Further it allows the temporary attaching, positioning, as well as easy removal and appearance of a logo or other type of embroidered design element 12 to a garment of any use, such as shirts, hats, dress, pants, and the like.

An article of clothing 20, such as a cowboy hat is an excellent example of an item that is not using the embroidery methods for decoration, since the hat owner does not want to risk the damaging of the cowboy hat nor are there commercially marketed machines designed to embroider cowboy hats.

Methods to make the magnets align for easy install and removal can be done in a variety of ways, such as but limited to—a flexible panel of magnets of such size or area so to accommodate various logo shapes and sizes, or a flexible panel that allows easy positioning of the magnets, so as to again accommodate the best conformity required for the logo matching the hat or garment, or magnets permanently affixed to wires for easy bending and placing so as to create the best fit of the embroidered part to conform to the hat, garment and the specific logo layout or form. Magnets can be of various sizes, shapes and attraction properties. Ferrous metal can be metal layers, metal laden polymer adhesives or metal parts made using shapes and sizes and properties to achieve the results intended by this invention. Further magnets or a magnetic surface may be used to oppose or attract to the other magnets on the other side of the garment or hat material.

Rare earth magnets (neodymium) may be the type of magnet in most cases, as they provide very strong magnetic properties as does ferrous alloy steels (e.g., industry 1010 tested) for the metal substrate as a “backer” for the embroidered part, however, other magnets are contemplated. Film steel metal alloy foils in a thickness in the range of from about 2 to about 10 millimeters may be used, however, any type of film or substrate may be used that is bendable and provides sufficient ferrous surface and magnetic potential for the magnets or rare earth magnets, such as neodymium, so as to have enough attraction to penetrate through the cloth, leather or garments structural material.

As shown in FIG. 2, such magnets 32 could also be affixed to a substrate 30, such as a plurality of recesses formed in the substrate 30 and the magnets 32 coupled within the plurality of recesses (foam panels tested then layer of clear film to keep from removal) or coated with a film to block magnetism going out its non-used side to provide a level of safety to the user, if desired. It will be understood that the magnets 32 may be permanently attached to the substrate 30, or in embodiments, the magnets 32 may be removably attached to the substrate. Permanent attachment to a wire for example or other substrate can also be incorporated for safety and avoid mishandling.

Embodiments allows the owner to use one hat or garment and change the design easily by incorporating magnets and a ferrous or other magnetic surface as described herein. Such metal/magnetic surface can also possibly be directly embroidered, eliminating the use of a receptive textile to then adhere or attach to the metal ferrous surface.

Conventional attaching requires a magnetic surface that is then slotted into a “pocket” or affixed to the hat/garment for example, and/or requires 2 magnets on each side for attraction with the one on the non-exposed side of the garment affixed or slotted to a space. The present invention does not require any prepositioning and is done at the user's choice.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A system for attaching design elements to an article of clothing, the system comprising:
an embroidered design element;
a conductive metal layer coupled to a back surface of the embroidered design element; and
a magnetic member, wherein the conductive metal layer is releasably and magnetically coupled to the magnetic member with an article of clothing between the conductive metal layer and the magnetic member.

2. The system of claim 1, wherein the conductive metal layer is a film.

3. The system of claim 2, wherein the film is a ferrous metal.

4. The system of claim 2, wherein the film is a metal laden polymer adhesive.

5. The system of claim 2, wherein the film is a steel metal alloy foil.

6. The system of claim 2, wherein the film has a thickness in the range of about 2 to about 10 millimeters.

7. The system of claim 2, wherein the film is bendable.

8. The system of claim 1, wherein the conductive metal layer is a non-metal substrate with a plurality of metal members coupled to formed within the non-metal substrate.

9. The system of claim 1, wherein the magnetic member is flexible.

10. The system of claim 1, wherein the magnetic member is a rare earth magnet.

11. The system of claim 10, wherein the rare earth magnet is neodymium.

12. The system of claim 1, wherein the magnetic member is removably attached to an inner surface of the article of clothing.

13. The system of claim 1, wherein the magnetic member is permanently attached to an inner surface of the article of clothing.

14. The system of claim 13, wherein the magnetic member is affixed to wire on the inner surface of the article of clothing.
